(19) United States
(12) Patent Application Publication
(10) Pub. No.: US 2018/0144586 A1
(43) Pub. Date: May 24, 2018

(54) ONBOARDING OF MOBILE-WALLET DATASETS

(71) Applicant: DIEBOLD NIXDORF, INCORPORATED, North Canton, OH (US)

(72) Inventors: Douglas K. HARTUNG, Kingwood, TX (US); Devon R. WATSON, North Canton, OH (US); Gregory R. SHIMEK, Akron, OH (US); Gary A. GANGER, Uniontown, OH (US)

(73) Assignee: DIEBOLD NIXDORF, INCORPORATED, North Canton, OH (US)

(21) Appl. No.: 15/568,577

(22) PCT Filed: Apr. 22, 2016
(86) PCT No.: PCT/US2016/028930

§ 371 Date: Oct. 23, 2017

Related U.S. Application Data
(60) Provisional application No. 62/151,770, filed on Apr. 23, 2015.

(51) Int. Cl. G07F 19/00; G06Q 20/32; G06Q 20/40; G06Q 20/20

(52) U.S. Cl. CPC G07F 19/211; G06Q 20/20; G06Q 20/401; G06Q 20/3221

(57) ABSTRACT

A system for onboarding banking-account information (an onboarding transaction) to be use in future transactions includes a banking-device terminal with a card-reading device to read a banking card and input device(s) to receive a verification input associating the banking card with a banking customer. One or more secure bank computing devices receive the banking-account information and the verification input and verify the banking-account information corresponds with the verification input to authorize the onboarding transaction. When the onboarding transaction is authorized, the at-least-one secure bank-computing device requests a customer-device identification of a mobile-customer device to be used for future-banking transactions. The secure bank computing device(s) receive the customer-device identification and store account data associated with the customer-device identification, the banking-account information and/or the verification input so that they may be used for future-banking transactions.

### CROSS REFERENCE TO RELATED APPLICATION

This patent application claims priority to U.S. provisional patent application Ser. No. 62/151,770 filed on Apr. 23, 2015, and its subject matter is hereby incorporated by reference.

### FIELD OF THE INVENTION

Various configurations of the current invention relate generally to apparatus, systems, and methods allowing a customer to store information related to banking. More particularly, the apparatus, systems and methods relate to allowing customers to store banking information from a banking card into a secured banking environment.

### BACKGROUND

At most modern cash machines, the customer is identified by inserting a plastic ATM card with a magnetic stripe or a plastic smart card with a chip that contains a unique card number and some security information such as an expiration date and a code verification value (CVV). Authentication is often provided by the customer entering a personal identification number (PIN).

Using a cash machine, customers can access their bank deposit or credit accounts in order to make a variety of transactions such as cash withdrawals, check balances, or credit mobile phones. In some instances, if the currency being withdrawn from the cash machine is different from that in which the bank account is denominated the money will be converted at an official exchange rate so that ATMs often provide the best possible exchange rates for foreign travelers. There remains a need for better ATM transactions and related systems and methods.

### SUMMARY OF THE INVENTION

One embodiment is a system for onboarding banking-account information to be used in future transactions. The system includes a banking-device terminal with a card-reading device to receive a banking card and to read banking-account information from the banking card. The banking-device terminal has other input device(s) for receiving a verification input associating the banking card with a banking customer, and to receive a request for an onboarding transaction. One or more secure bank computing devices receive the banking-account information and the verification input and verify the banking-account information corresponds with the verification input to authorize the onboarding transaction. Alternatively, the secure bank computing device(s) will not authorize the onboarding transaction when the banking-account information does not correspond with the verification input. When the onboarding transaction is authorized, the secure bank computing device(s) request a customer-device identification of a mobile-customer device to be used for future-banking transactions. To complete the onboarding process, the secure bank computing device(s) receive the customer-device identification and store account data associated with the customer-device identification, the banking-account information and/or the verification input so that they may be used for the future-banking transactions.

Another embodiment is a method of onboarding financial data. The method begins by reading banking-account information from a banking card. This is preferably performed on an ATM or a point of sale (POS) device located in a secure location such as a bank or at a retail establishment. A verification input is also read that associates the banking card with a banking customer. The verification input is used to verify on a secure-banking system that the banking-account information corresponds with the verification input. If the verification is successful, a request is made for a customer-device identification of a mobile-customer device. For example, the customer-device identification may be a phone number of a mobile phone. After the onboarding, the customer device may be used for future-banking transactions without requiring the banking card's presence. The customer-device identification is stored in a secured portion of a banking system with at least portions of the banking-account information and the verification input. This stored data may later be used for the future-banking transactions based on a banking account associated with the banking card without requiring the banking card.

Another embodiment is a system for performing onboarding of data associated with a customer-banking account. The system includes a banking device that may be an exemplary ATM or POS. The banking device has a first input device for reading banking-account information associated with the customer-banking account from a banking card issued to a banking customer. A second input device on banking device is configured to receive verification data that the banking customer is associated with the banking card. The secured-banking system receives and verifies the banking-account information matches the verification data. When there is a valid verification, the banking device requests device identification information that identifies a personal device the banking customer will use to request future transactions using the customer-banking account. The secured-banking system stores account information corresponding to the banking-account information, the verification data and/or the device identification information so that the stored account information may be later retrieved to perform future transactions without using the banking card.

### BRIEF DESCRIPTION OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples, one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example system for onboarding banking-account information from a banking card to a secure bank computing device.

FIG. 2 illustrates another example system for onboarding banking-account information from a banking card to a secure-banking system.

FIGS. 3A and 3B illustrate another example system for onboarding banking-account information from a banking card to a secure-banking system.

FIG. 4 is an example flow diagram illustrating an embodiment of a method for ATM onboarding of a mobile-wallet data set.

FIG. 5 is an example flow diagram illustrating an embodiment of a method of onboarding banking-account information from a banking card to a secure bank computing device.

FIG. 6 is an example computing environment in which various embodiments or portions of embodiments may operate.

### DETAILED DESCRIPTION OF THE DRAWINGS

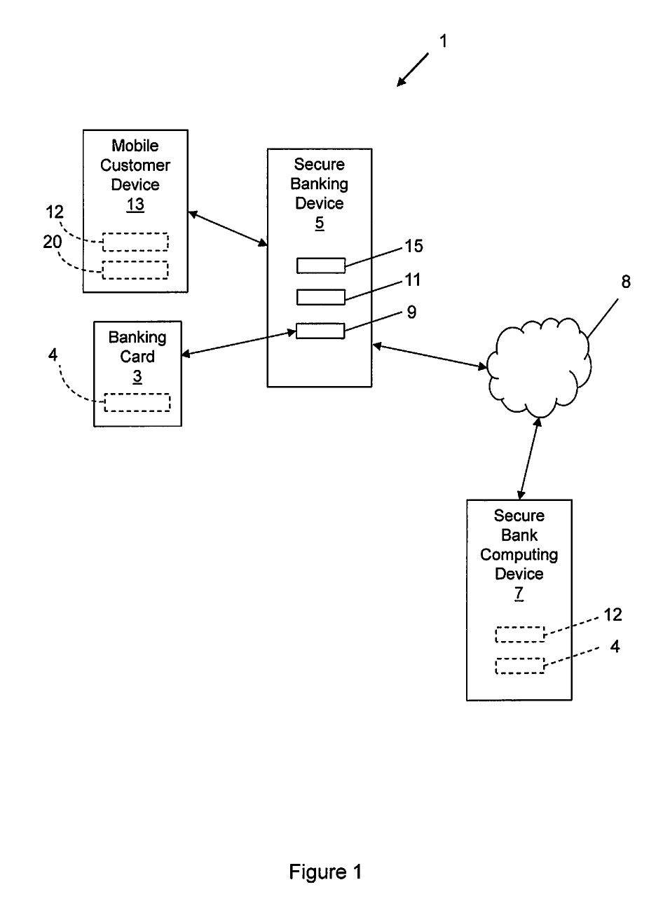

Details are set forth in the following description and in FIGS. 1-6 to provide a thorough understanding of various embodiments of the invention. Those of ordinary skill in the art will understand that the example embodiments may have additional components and configurations that may be practiced without several of the details described below. In some instances, persons of ordinary skill in the art will appreciate that the methods and systems described herein can include additional details without departing from the spirit or scope of the disclosed embodiments. Additionally, some known structures and systems associated with automated transaction machines (ATMs), mobile devices, and associated computer networks have not been shown or described in detail below to avoid unnecessarily obscuring the described embodiments.

Additionally, functionality of components of the systems described below may be implemented with one or more processors executing software instructions and/or be implemented with other hardware logic. “Processor” and “Logic”, as used herein, includes but is not limited to hardware, firmware, software and/or combinations of each to perform a function(s) or an action(s), and/or to cause a function or action from another logic, method, and/or system. For example, based on a desired application or needs, logic and/or processor may include a software-controlled microprocessor, discrete logic, an application specific integrated circuit (ASIC), a programmed logic device, a memory device containing instructions or the like. Logic and/or processor may include one or more gates, combinations of gates, or other circuit components. Logic and/or a processor may also be fully embodied as software. Where multiple logics and/or processors are described, it may be possible to incorporate the multiple logics and/or processors into one physical logic (or processors). Similarly, where a single logic and/or processor is described, it may be possible to distribute that single logic and/or processor between multiple physical logics and/or processors.

FIG. 1 illustrates one example embodiment of a system 1 for “onboarding” of banking-account information 4 from a banking card 3 at a banking-device terminal 5 and then onto a secure bank computing device(s) 7 such as a secured computer, server or other device that may securely store information 4 from banking card 3. Onboarding is the general process of an owner of the banking card 3 uploading banking-account information 4 stored on the card to the secure bank computing device 7 along with optionally uploading other personal information. This information 4 is stored on the secure bank computing device(s), weeks, months, years or until an account associated with the stored account information is closed and the stored account information is removed/deleted from the bank computing device(s) 7 or removed in another affirmative way. A banking customer that has already onboarded the required information from the card 3 to the secure bank computing device 7 may, in the future, return to a banking-device terminal 5 or another similar device and conduct future banking financial transaction(s) where the customer normally needs to be present with their card. However and as discussed further below, when the banking information 4 has been prior onboarded to the secure bank computing device 7, the customer may return to the banking-device terminal 5 or similar device and still conduct transactions without their card being present by verifying their personal presence without their card, for example, by identifying themselves with biometric data to begin a financial transaction.

In essence, onboarding provides a way of moving existing security credentials from the banking card 3 to the secure bank computing device 7 (e.g., server) and a mobile-customer device 13 (discussed below) such as a cell phone that is carried by a banking customer. For example, in the future, the owner of the credit card 3 may return to the banking-device terminal (e.g., ATM) or a different terminal and conduct a financial transaction with an account linked to the banking card 3 without needing to use or have the banking card present. The mobile security device 13 of the customer provides security credentials linked to the onboarded account information stored in the secure bank computing device 7 to authorize transactions to the corresponding bank account without requiring use of the banking card 3.

The banking card 3 may be a bank issued card associated with a savings account, a checking account with a bank or another type of account. In some embodiments, banking card 3 may be a credit card, debit card or another type of card. Banking-device terminal 5 may be an automatic transaction machine (ATM), a point of sale (POS), a bill pay terminal or another type of device as understood by those of ordinary skill in the art. In some embodiments, preferably the banking-device terminal 5 is located in an at least a partially secure area such as at a bank or inside a retail establishment to provide a customer using the terminal 5 a sense of security so that they will feel free to upload their data from their card 3 as well other data or personal data to the secure bank computing device 7. Of course, the banking-device terminal 5 may be connected to one or more networks 8, including the internet so that signals traveling between the bank computing device 7 and the banking-device terminal 5 will travel through those networks 8 before reaching the bank computing device 7.

In some configurations, the banking-device terminal 5 includes a card-reading device 9 for receiving the banking card 3 and reading banking-account information 4 from the banking card 3. The banking-device terminal 5 further has at-least-one input device for receiving a verification input that associates the banking card with a banking customer. For example, the input device may include a keypad 11 allowing a customer to input a personal identification number (PIN), iris scan, fingerprint and/or another item that is unique to that customer. This provides a level of security to ensure that the person onboarding (uploading) a bank account to the banking-device terminal 5 is the actual owner of the banking card 3. The input device may also be used for receiving a request for an onboarding transaction that indicates to the banking-device terminal 5 that the customer of the banking card 3 desires to upload (onboard) data from their card 3 to the bank computing device 7.

Upon verifying that the customer is an authorized user of the banking card 3 and has permission to onboard their banking information to 4 the secure bank computing device 7, the onboarding transaction is authorized. When authorized, the secure bank computing device 7 is configured to request a customer-device identification 12 of the mobile-customer device 13 to be used for future-banking transactions. This request is generated and activated by any way as understood by those in ordinary skill in the art. For example, the request for the customer-device identification 12 may be generated by processor logic in the banking-device terminal 5 and displayed on a display 15 on the terminal 5. For example, the customer-device identification 12 may be a numeric phone number that the customer enters into the keypad 11. The banking-device terminal 5 receives the customer-device identification 12 and begins the process of transmitting and storing account data 4 associated with a banking account being onboarded to the secure bank computing device 7. Having collected and stored account information 4 associated with the banking card 3 and the customer-device identification 12, allows this information to later be used for future-banking transactions without requiring the presence of the banking card 3.

In other embodiments, data collected at the banking-device terminal 5 and stored at the secure bank computing device(s) 7 may be referred to as a “mobile wallet dataset”. The mobile wallet dataset includes a personal banking card data set and a personal information data set that may also be collected and onboarded to the secure bank computing devices(s) 7. The personal banking card data set may correspond to a bank card, credit card or a debit card and may include information such as an account information number, a card verification value CVV, and expiration data, and the like with the personal information data including such things as card holder's name, address, phone number(s) and/or social security number and the like.

In some configurations, after a customer has onboarded an account associated with a first banking account from a banking card, they may be prompted at the secure banking terminal 5 if they desire to upload a second banking account associated with another banking card. Having already entered their verification input (e.g., PIN) and customer-device identification 12 (e.g., phone number) for their mobile-customer device (e.g., cellular phone), they would not need to reenter this information because they have already been authenticated as the owner of the first banking card. They would simply be required to have the banking-device terminal 5 read their second banking account read from the second banking card and confirm that they desire to onboard that data to the secure bank computing device(s) 7.

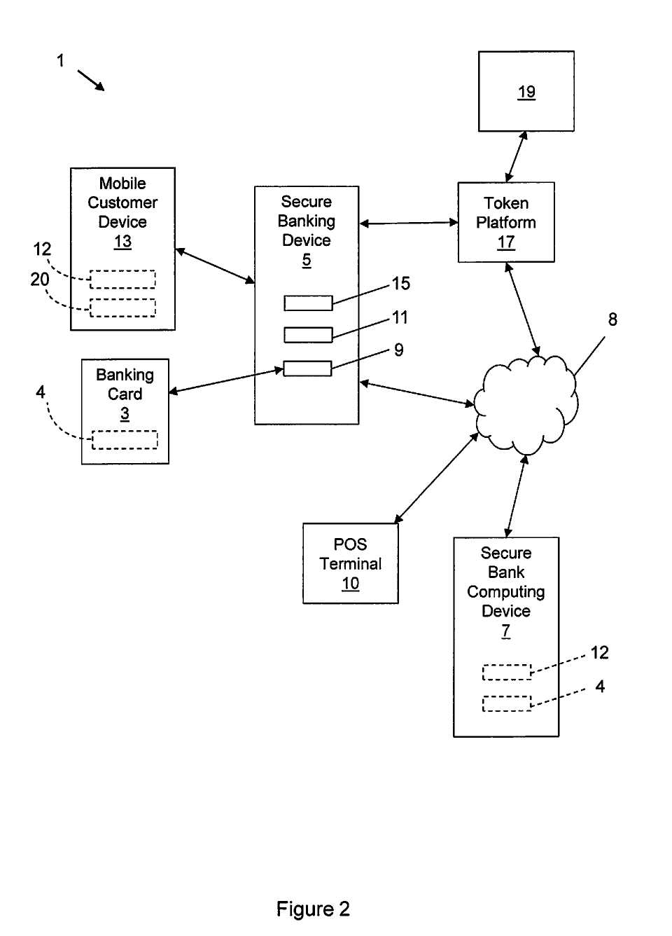

In other configurations and as illustrated in FIG. 2, the system 1 for onboarding of banking-account information further includes a token platform 17. The token platform 17 creates tokenized data of one of more of: the customer-device identification, the banking-account information and the verification input where the account data is the tokenized data. The system 1 may also include a software application 20 and/or a device-validation engine 19. The application 20 is downloaded onto the banking-device terminal 5 and is used to request the future-banking transactions from the banking-device terminal 5. In some configurations, the application 20 may be password or PIN protected to provide a level of security preventing someone that is not an owner of the mobile-customer device 13 or of the banking-account information on the banking card 3 from accessing the software application 20. The tokenized platform 17 interrogates the device-validation engine 19. When there is a successful interrogation, the token platform provides the mobile-customer device 13 with a link for downloading the application 20 to the mobile-customer device 13. The device-validation engine 19 may perform the interrogation by determining if one or more of the customer-device identification 12 and the banking-account information 4 are consistent with a corresponding name in a pre-known billing record. For example, the pre-known billing record may be a mobile network operator (MNO) billing record that may be provided by a telecommunications service provider organization that provides wireless voice and data communication for its customers.

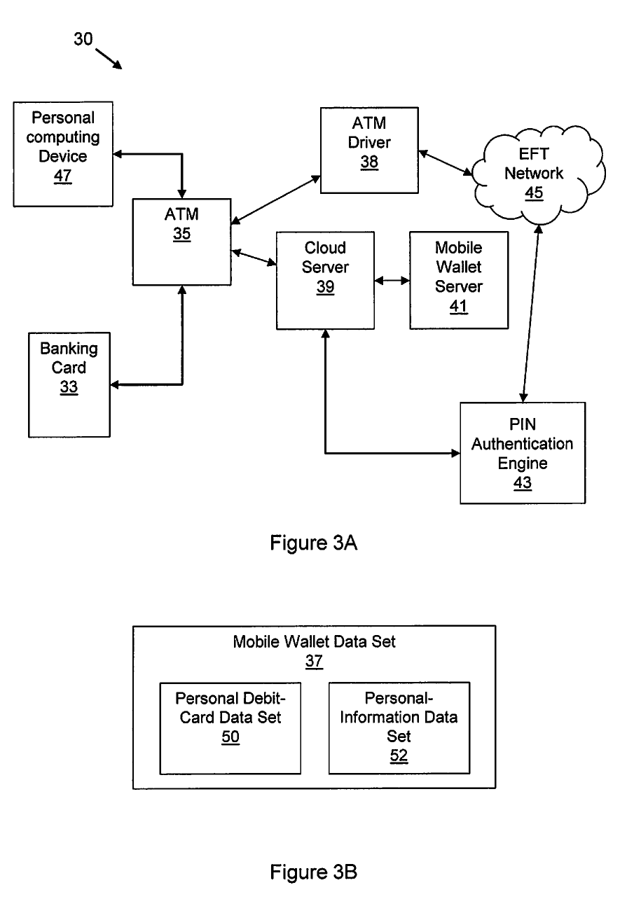

FIGS. 3A-B illustrates another example system 30 of onboarding banking information from a banking card 33 for creating a mobile-wallet data set 37 using an ATM 35 configured for onboarding of the mobile-wallet data set 37. Upon completion of the onboarding the banking information, a personal computing device may be used to later initiate a card-less ATM transaction using the mobile-wallet data set 37. Embodiments of FIG. 3A are generally described in the context of computer-readable logic executed by one or more general-purpose computers. For example, in a portion of an embodiment, computer readable logic is stored on a server computer system and accessed by a client computer via a communications link or a network, such as an intranet, Internet, virtual private network, or another computer network. Because the basic structures and functions related to computer-readable routines and corresponding implementations are known, they have not been shown or described in detail below to avoid unnecessarily obscuring the described embodiments.

The example embodiment of FIG. 3A includes an ATM driver 38 and a cloud server 39 in communication with the ATM 35. One or more mobile-wallet servers 41 are in communication with the cloud server 39. A PIN authorization engine 43 is also in communication with the cloud server 39. An electronic funds transfer network 45 is in communication with both the PIN authorization engine 43 and the ATM driver 38. A personal computing device 47 is in operative connection with the ATM 35 and optionally the cloud server 39

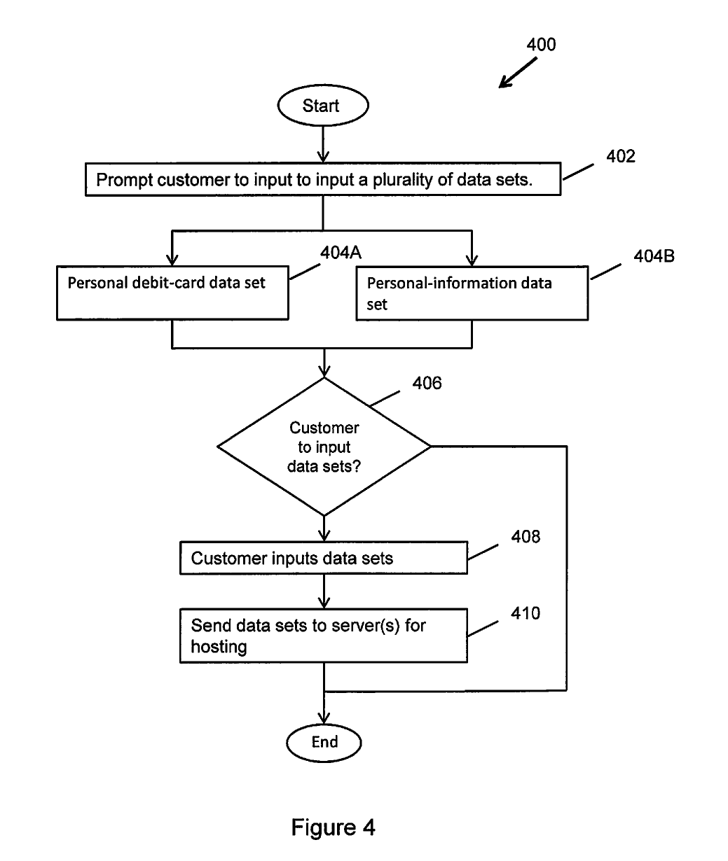

The functionality of the example system of FIG. 3A will be further explained with reference to an example method and the flow diagram of FIG. 4. While for purposes of simplicity, explanation of the illustrated methodologies are shown and described as a series of blocks. It is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

FIG. 4 illustrates an example flow diagram of how a customer can create a mobile-wallet data set 37 by using personal computing device 47 (e.g., a computing tablet or mobile phone) to input a plurality of data sets that together make up mobile-wallet data set 37. Mobile-wallet data set 37 is a collection of one or more electronic data sets that may include at least one personal debit-card data set 50 (e.g., a data set that provides debit-card number, CVV number, and expiration-date information) and at least one personal-information data set 52 (e.g., cardholder name). In an embodiment, mobile-wallet data set 37 may include a data set associated with a credit or debit card distinct from personal debit-card data set 50 mentioned above.

Block 402 (FIG. 4) illustrates the method 400 begins with a customer being prompted to create mobile-wallet data set 37 by using personal computing device 47 to input a plurality of data sets that include the personal debit-card data set 50 and the personal-information data set 52, shown respectively in blocks 404A and 404B. In decision block 406, the customer decides whether to input the prompted data sets (i.e., the personal debit-card data set 50 and personal-information data set 52). The customer inputs the requested data sets, at 408, by using the personal computing device 47 and/or the ATM 35 to populate the data fields prompted to the customer with the requested data sets making up the mobile-wallet data set 37. In response to populating the prompted data fields, the ATM 35 sends the mobile-wallet data set 37 to the cloud server 39 that then forwards the mobile-wallet data set 37 to mobile-wallet server 41 for hosting, at 410. In other configurations, the personal computing device 47 may send some or all of this data directly to the mobile wallet server 41 for hosting.

In another embodiment, personal computing device 47 sends mobile-wallet data set 37 to server 39 that executes an algorithm on at least a portion of mobile-wallet data set 37 and thereby determines the appropriate host-server destination for mobile-wallet data set 37. In response to reaching this algorithm-driven-host-server-destination determination, mobile-wallet data set 37 is then forwarded from server 39 to the identified host-server destination from amongst a plurality of host servers. In an embodiment, server 39 may have a plurality of host-server destinations to select from, where the host-server destinations are specific as to the type of mobile-wallet data set 37 that they each respectively host. For example, each host-server destination (i.e., host server) may respectively host different types of mobile-wallet data set(s) 37. Mobile-wallet data set 37 may include data that the algorithm (performed on server 39) determines is associated with a specific banking institution, and in response to reaching this determination, causes mobile-wallet data set 37 to be forwarded from server 39 to the dedicated host server for that specific bank or bank data. As an illustrative example, mobile-wallet data set 37 relating to ABC bank is sent from server 39 to a host server dedicated to hosting ABC-bank mobile-wallet data sets; mobile-wallet data set 37 relating to DEF bank is sent from server 39 to a host server dedicated to hosting DEF-bank mobile-wallet data sets. Likewise, a mobile-wallet data set 37 relating to GHI bank is sent from server 39 to a host server dedicated to hosting GHI-bank mobile-wallet data sets, and so on.

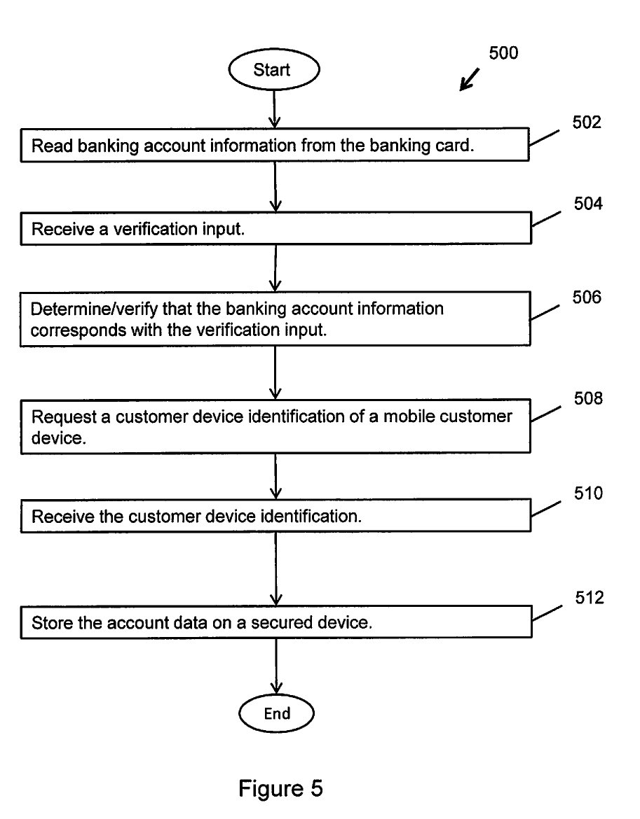

FIG. 5 illustrates a method 500 of onboarding financial data. The method 500 begins by reading banking-account information from the banking card, at 502. As mentioned above, the card may be read by a card reader at an ATM or a POS device located in a secure location to prevent tampering with the ATM or POS device. Next, the ATM, or other device, receives a verification input, at 504, that associates the banking card with a banking customer. This may be a PIN or other personal information/biometric information of an owner of the card. The secure-banking system determines/verifies that the banking-account information corresponds with the verification input, at 506. When the verification is successful, a customer-device identification of a mobile-customer device is requested, at 508, and the customer-device identification is received, at 510. As discussed above, this may be a request for a mobile phone number of a mobile phone that will later be used to request transactions at a different time using the onboarded banking-account information. One or more of the account data including the customer-device identification, the banking-account information and the verification input are stored on a secured device such as a secured server, at 512, so that this data may be used for future-banking transactions. In some embodiments, the method 500 may perform future-banking transactions that are later performed at an automatic transaction machine (ATM) without accessing the banking card.

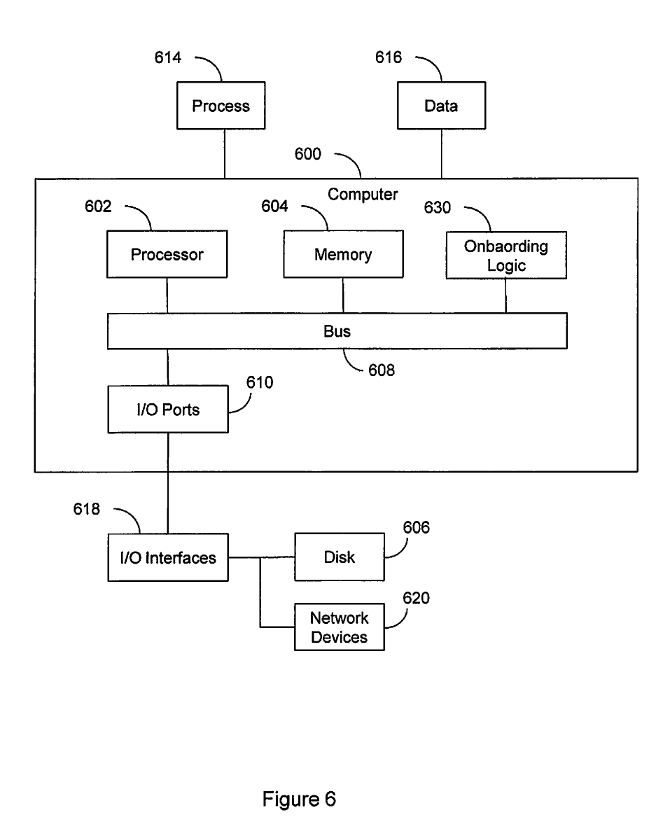

FIG. 6 illustrates an example computing device in which example systems and methods described herein, and equivalents, may operate. The example computing device may be a computer 600 that includes a processor 602, a memory 604, and input/output ports 610 operably connected by a bus 608. In one example, the computer 600 may include an onboarding logic 630 configured to assist a customer in onboarding account data from a banking card at an ATM. In different examples, onboarding logic 630 may be implemented in hardware, software, firmware, and/or combinations thereof. Thus, logic 630 may provide means (e.g., hardware, software, firmware) for receiving banking information from a banking card and preparing it to be stored on a portion of remote banking computer system to be used at a another time without requiring the customer to later present the banking card at an ATM after the onboarding. While logic 630 is illustrated as a hardware component attached to bus 608, it is to be appreciated that in one example, logic 630 could be implemented in processor 602.

Generally describing an example configuration of computer 600, processor 602 may be a variety of various processors including dual microprocessor and other multi-processor architectures. Memory 604 may include volatile memory and/or non-volatile memory. Non-volatile memory may include, for example, ROM, PROM, EPROM, and EEPROM. Volatile memory may include, for example, RAM, synchronous RAM (SRAM), dynamic RAM (DRAM), synchronous DRAM (SDRAM), double data rate SDRAM (DDR SDRAM), direct RAM bus RAM (DRRAM) and the like.

A disk 606 may be operably connected to computer 600 via, for example, an input/output interface (e.g., card, device) 618 and an input/output port 610. Disk 606 may be, for example, a magnetic disk drive, a solid state disk drive, a floppy disk drive, a tape drive, a Zip drive, a flash memory card, and/or a memory stick. Furthermore, disk 606 may be a CD-ROM, a CD recordable drive (CD-R drive), a CD rewriteable drive (CD-RW drive), and/or a digital video ROM drive (DVD ROM). Memory 604 can store a process 614 and/or a data 616, for example. Disk 606 and/or memory 604 can store an operating system that controls and allocates resources of computer 600.

Bus 608 may be a single internal bus interconnect architecture and/or other bus or mesh architectures. While a single bus is illustrated, it is to be appreciated that computer 600 may communicate with various devices, logics, and peripherals using other busses (e.g., PCIE, SATA, Infiniband, 1384, USB, Ethernet). Bus 608 can be types including, for example, a memory bus, a memory controller, a peripheral bus, an external bus, a crossbar switch, and/or a local bus.

Computer 600 may interact with input/output devices via input/output interfaces 618 and input/output ports 610. Input/output devices may be, for example, a keyboard, a microphone, a pointing and selection device, cameras, video cards, displays, the disk 606, the network devices 620, and so on. The input/output ports 610 may include, for example, serial ports, parallel ports, USB ports and the like.

The computer 600 can operate in a network environment and thus may be connected to network devices 620 via input/output interfaces 618, and/or the input/output ports 610. Through network devices 620, computer 600 may interact with a network. Through the network, computer 600 may be logically connected to remote computers. Networks with which computer 600 may interact include, but are not limited to, a local area network (LAN), a wide area network (WAN), and other networks. The networks may be wired and/or wireless networks.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example” and so on, indicate that the embodiment(s) or example(s) so described may include a particular feature, structure, characteristic, property, element, or limitation, but that not every embodiment or example necessarily includes that particular feature, structure, characteristic, property, element, or limitation.

What is claimed is:

1. A system comprising:
a banking-device terminal comprising:
a card-reading device configured to receive a banking card and to read banking-account information from the banking card;
at-least-one input device configured to receive a verification input that associates the banking card with a banking customer, and wherein the at-least-one input device is adapted to receive a request for an onboarding transaction; and
an at-least-one secure bank-computing device configured to receive the banking-account information and the verification input and to verify the banking-account information corresponds with the verification input to authorized the onboarding transaction, wherein the at-least-one secure bank-computing device is configured to not authorize the onboarding transaction when the banking-account information does not correspond with the verification input, wherein when the onboarding transaction is authorized the banking-device terminal is configured to request a customer-device identification of a mobile-customer device to be used for future-banking transactions, and wherein the at-least-one secure bank-computing device is configured to receive the customer-device identification and to store account data associated with at least one of the group consisting of the customer-device identification, the banking-account information and the verification input to be used for the future-banking transactions.

2. The system of claim 1 wherein the future-banking transactions are performed by accessing the at-least-one secure bank-computing device without accessing the banking card.

3. The system of claim 1 wherein the mobile-customer device is a phone.

4. The system of claim 3 wherein the customer-device identification is a phone number.

5. The system of claim 1 wherein banking terminal device is selected from the group consisting of an automatic transaction device (ATM) and a point of sale (POS) device.

6. The system of claim 1 wherein the at-least-one input further comprises:
a keypad.

7. The system of claim 1 wherein the verification input is a personal identification number (PIN).

8. The system of claim 1 further comprising:
a token platform configured to create tokenized data of at least one of the group of: the customer-device identification, the banking-account information and the verification input, wherein the banking-account information stored on the at-least-one secure bank-computing device is the tokenized data.

9. The system of claim 8 further comprising:
an application used to request the future-banking transactions, wherein the application is software protected; and
a device-validation engine, wherein the tokenized platform is configured to interrogate the device-validation engine, wherein upon a successful interrogation the token platform is configured to provide the mobile-customer device with a link for downloading the application to the mobile-customer device.

10. The system of claim 9 wherein the device-validation engine is configured to perform the interrogation by determining if the at least one of the group of: the customer-device identification and the banking-account information are consistent with a corresponding name in a pre-known billing record.

11. The system of claim 10 wherein the pre-known billing record is a mobile network operator (MNO) billing record.

12. The system of claim 1 further comprising:
an application used to request the future-banking transactions, wherein when the onboarding transaction is authorized the at-least-one secure bank-computing device is configured to send data for downloading the application to the mobile-customer device.

13. The system of claim 1 wherein the at-least-one input device further comprises:
a biometric data input device and wherein the verification input is selected from the group consisting of a scan of a portion of an eye of the banking customer and a scan of a portion of a fingerprint of the banking customer.

14. The system of claim 1 wherein the banking-account information further comprises:
data associated with the banking customer; and
data associated with a banking account corresponding to the banking customer.

15. The system of claim 1 wherein the banking card is a credit card wherein the system moves existing security credentials from the banking card to the secure bank computing device and the mobile-customer device.

16. A method of onboarding financial data comprising:
reading banking-account information from the banking card;
receiving a verification input that associates the banking card with a banking customer;
verifying on a secure-banking system that the banking-account information corresponds with the verification input;
when the verification is successful requesting a customer-device identification of a mobile-customer device, wherein the customer device is to be used for a future-banking transaction;
receiving the customer-device identification; and
storing account data associated with at least one of the group consisting of the customer-device identification, the banking-account information and the verification input to be used for the future-banking transaction.

17. The method of claim 16 wherein the future-banking transaction is later performed at an automatic transaction machine (ATM) without accessing the banking card.

18. The method of claim 16 wherein the mobile-customer device is a phone.

19. A system for performing onboarding of data associated with a customer-banking account comprising:
a banking device with a first input device configured to read banking-account information associated with the customer-banking account from a banking card issued to a banking customer;
a second input device on the banking device configured to receive verification data that associates the banking customer with the banking card; and
a secured-banking system configured to receive and verify that the banking-account information matches the verification data and requests device identification information that identifies a personal device that the banking customer may use to request future transactions using the customer-banking account, wherein the secured-banking system is configured to store-account information corresponding to at least one of the group consisting of the banking-account information, the verification data and the device identification information so that the stored account information is configured to later be retrieved to perform future transactions without using the banking card.

20. The system for performing onboarding of data associated with a customer-banking account of claim 19 wherein the banking device is an ATM, the verification data is a PIN, the personal device is a mobile phone and the device identification information is a phone number of the mobile phone.
